(19) United States
(12) Patent Application Publication
(10) Pub. No.: US 2008/0090548 A1
(43) Pub. Date: Apr. 17, 2008

(54) Method for tracking mobile communication terminal

(75) Inventor: Balaji Vijayanagaram Ramalingam, Bangalore (IN)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/901,097

(22) Filed: Sep. 15, 2007

(30) Foreign Application Priority Data
Sep. 14, 2006 (IN) 1677/CHE/2006
Aug. 31, 2007 (KR) 88207/2007

(51) Int. Cl. H04M 11/04

(52) U.S. Cl. 455/404.2

(57) ABSTRACT

Disclosed is a method for tracking a mobile communication terminal. The method includes configuring a mobile tracking feature; creating mobile tracking information when there is a difference between Subscriber Identity Module (SIM) card information stored in a SIM card currently being inserted into the mobile communication terminal and SIM card information stored in a memory after the mobile communication terminal is switched on, the mobile tracking information including current location information of the mobile communication terminal; and sending the mobile tracking information by generating a call to a pre-defined emergency call number.

### PRIORITY

This application claims priority under 35 U.S.C. §119(a) to Patent Applications entitled “Method For Tracking Lost Mobile Communication Terminal” filed in the Indian Patent Office on Sep. 14, 2006 and assigned Serial No. 1677/CHE/2006, and filed in the Korean Intellectual Property Office on Aug. 31, 2007 and assigned Serial No. 10-2007-0088207, the contents of each of which are incorporated herein by reference.

### BACKGROUND OF THE INVENTION

1. Field of the Invention

The present invention relates generally to a wireless communication system, and in particular, to a method for tracking a mobile communication terminal when the mobile communication terminal has been lost.

2. Description of the Related Art

Today, conventional mobile communication terminals with Subscriber Identity Module (SIM) cards use a short message or an E-mail message to process newly changed SIM card information and current International Mobile Subscriber Identity (IMSI), old Mobile Subscriber International Subscriber Dialing Number (MS ISDN), and IMSI along with current cell and location information. However, in many cases, the newly inserted SIM card can be void of important SIM card information, thus, rendering this technology ineffective.

There are, in the prior art, teachings of mobile communication terminals that include tracking techniques for tracking a mobile terminal when it is either lost or stolen. One example in the prior art is U.S. Pat. No. 5,862,472 issued to Park. In U.S. Pat. No. 5,862,472, a circuit and method for a mobile communication terminal which prevents a finder from exploiting the interests of the owner if the telephone becomes lost is described. The method includes generating an audible alarm and a first message requesting input of a predetermined password when one of a predetermined time period elapses and a number of outgoing calls exceeds a predetermined number after an alarm function is enabled; detecting whether the predetermined password is input, and stopping generation of the alarm and the first message when the predetermined password is input; generating a second message indicating how an owner of the mobile communication terminal can be contacted and activating a loss mode of the mobile communication terminal when the predetermined password is not inputted; and automatically dialing a telephone number corresponding to the owner when a predetermined key on the mobile communication terminal is input after the loss mode is activated. However, the authentication process is carried out by password entry and not by comparing the IMSI numbers. Moreover, the mobile phone in the method above does not automatically dial the owner's number, but waits for the user to dial specific numbers and then initiates dialing of the owner's number.

Another example is found in U.S. Patent Publication No. 2003/0087627 issued to Cannon describing a method where a lost or stolen mobile communication terminal is restricted by the activation of a temporary recovery mode service by their service provider pursuant to a call from the subscriber on another phone. The temporary recovery mode service permits the user to select any one of a plurality of possible temporary recovery mode options. Preferably, the temporary recovery mode options limit or entirely restrict further expense incurred by the use of the wireless device until it is found and the recovery service is deactivated. Moreover, in the patent to Cannon, an exemplary temporary recovery mode option includes the step of allowing the missing mobile terminal to only receive calls or to allow local outgoing calls only. Another temporary recovery mode option allows full functionality of the mobile terminal only until the monthly plan allotment of free minutes is used up, and then automatically disables use of the mobile communication terminal, or then automatically allows only calls to be received, or only local calls to be made, or, further, only calls to certain telephone numbers are permitted. However, in the patent to Cannon, the mobile communication terminal does not automatically send user information to the owner. Moreover, the function restriction of the stolen or lost mobile communication terminal is performed by the service provider and not by the stolen or lost mobile communication terminal.

### SUMMARY OF THE INVENTION

An aspect of the present invention is to substantially solve the above-mentioned problems and/or to provide at least the advantages below. Accordingly, one aspect of the present invention is to provide a method for tracking a lost mobile communication terminal, in which the mobile communication terminal itself can initiate tracking by using Subscriber Identity Module (SIM) card information.

According to one aspect of the present invention, there is provided a method for tracking a mobile communication terminal. The method includes configuring a mobile tracking feature; creating mobile tracking information when there is a difference between Subscriber Identity Module (SIM) card information stored in a SIM card being currently inserted and SIM card information stored in a memory when being compared with each other while the mobile communication terminal is switched on, the mobile tracking information including current location information of the mobile communication terminal; and sending the mobile tracking information by generating a call to pre-defined emergency call numbers.

Preferably each of the SIM card information includes International Mobile Subscriber Identity (IMSI) and Mobile Subscriber International Subscriber Number (MS ISDN).

It is also preferable that the mobile tracking information further includes IMSI and MS ISDN stored in the SIM card being currently inserted and IMSI and MS ISDN stored in the memory.

It is also preferable that the step of configuring the mobile tracking feature comprises storing the emergency call numbers to the memory corresponding to user selection of the emergency call numbers.

It is also preferable that the step of configuring the mobile tracking feature further comprises storing IMSI and MS ISDN stored in a SIM card being inserted into the mobile communication terminal at the time of storing the emergency call numbers to the memory along with the emergency call numbers.

It is also preferable that the step of configuring the mobile tracking feature further comprises storing IMSI and MS ISDN input by the user to the memory along with the emergency call numbers.

It is also preferable that the step of configuring the mobile tracking feature further comprises setting a password for the protection of the mobile tracking feature.

It is also preferable that the step of sending the mobile tracking information comprises creating user-user information Information Element (IE) containing the mobile tracking information, and including the user-user information IE into a call set up message.

It is also preferable that the step of sending the mobile tracking information comprises giving a call to the emergency call numbers using the call set up message.

It is also preferable that the method further comprises, when a call set up indication is received, extracting the mobile tracking information from the call set up indication and providing the mobile tracking information to the user.

It is also preferable that the mobile tracking information is a short message.

### BRIEF DESCRIPTION OF THE DRAWINGS

The above and other aspects, features and advantages of the present invention will be more apparent from the following detailed description taken in conjunction with the accompanying drawings, in which:

FIG. 1 is a view illustrating a block diagram of a mobile communication terminal to which the present invention is applied;

FIG. 2 is a flowchart illustrating a configuration process of a mobile tracking feature according to the present invention;

FIG. 3 is a flowchart illustrating a process of a mobile communication terminal of an originating side according to the present invention; and

FIG. 4 is a flowchart illustrating a process of a mobile communication terminal of a terminating side according to the present invention.

### DETAILED DESCRIPTION OF THE PREFERRED EMBODIMENTS

Hereinafter, exemplary embodiments of the present invention will be described with reference to the accompanying drawings. In the following description of the present invention, a detailed description of known functions and configurations incorporated herein will be omitted when it may make the subject matter of the present invention rather unclear.

The present invention provides a method for tracking a lost mobile communication terminal, in which the lost mobile communication terminal automatically generates a missed call which includes tracking information containing information of a Subscriber Identity Module (SIM) card currently mounted thereto and a current location thereof to pre-defined terminating sides, and mobile communication terminals of originating sides, which receive the missed call, use the information included in the received call, thereby allowing the tracking of the lost mobile communication terminal. Here, the lost mobile communication terminal passes the mobile tracking information to the pre-defined set of numbers by generating the missed call internally.

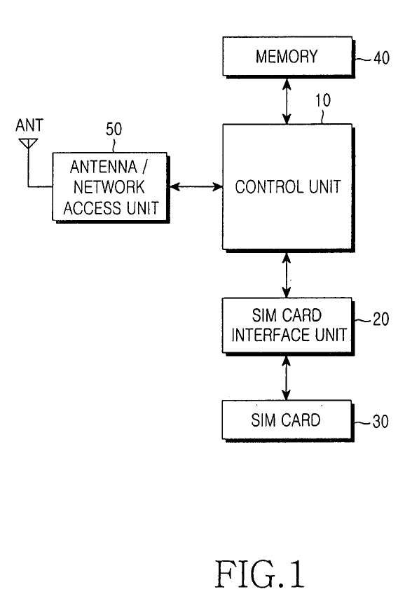

FIG. 1 is a block diagram of the mobile communication terminal to which the present invention is applied. In FIG. 1, the mobile communication terminal includes a control unit 10, a SIM card 30, a SIM card interface unit 20, a memory 40, and an antenna/network access unit 50.

The control unit 10 is operable to control and manage the general operation of the mobile communication terminal.

The SIM card 30 is operable to store user authentication information including the International Mobile Subscriber Identity (IMSI) and the Mobile Subscriber International Subscriber Dialing Number (MS ISDN), communication encryption information, and other various user information. The control unit 10 performs mobile communication using information stored in the SIM card 30 when a session with the SIM card 30 is established.

The SIM card interface unit 20 is a component connecting the control unit 10 and the SIM card 30 to each other, through which the control unit 10 may establish or drop the session with the SIM card 30, store various information into the SIM card 30, and retrieve stored information from the SIM card 30.

The memory 40, which provides working memory, stores programs for the processing and control of the control unit 10, reference data, and various data to be maintained. Also, the memory 40 stores mobile tracking feature application data according to the present invention. Also, the memory 40 stores emergency call numbers to be input while registering the mobile tracking feature, SIM card information, IMSI, MS ISDN, and passwords for user protection of the tracking application.

The antenna/network access unit 50, which transmits and receives radio signals to and from the mobile stations via its antenna, includes a baseband processing unit to modulate signals input from the control unit 10 which are then transmitted as RF signals via the antenna and demodulates RF signals received via the antenna to provide demodulated signals to the control unit 10.

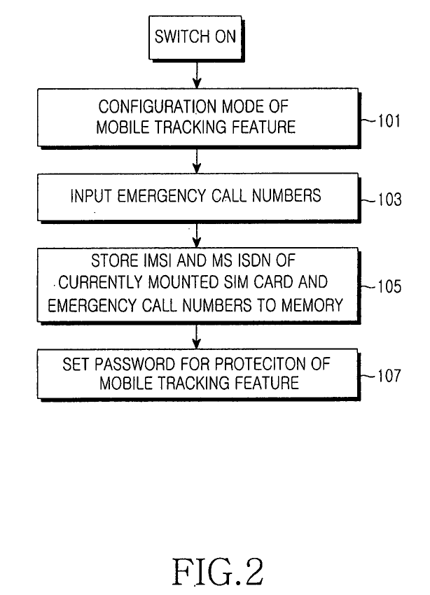

Hereinafter, a registration process of the mobile tracking feature on the mobile communication terminal is described below with reference to FIG. 2. FIG. 2 is a flowchart illustrating a configuration process of the mobile tracking feature according to an embodiment of the present invention.

In this case, the user requests execution of the mobile tracking application and configuration of the mobile tracking feature. Hence, the mobile communication terminal enters a configuration mode of the mobile tracking feature at step 101 and proceeds to step 103. At step 103, the mobile communication terminal prompts the user to perform user inputs by displaying, for example, an input window to which the user can input the emergency call numbers. The user may input one or more phone numbers to which mobile tracking information is sent in case the mobile communication terminal is ever lost or stolen.

At step 105, the mobile communication terminal stores SIM card information including the IMSI and the MS ISDN of a SIM card currently being inserted thereto and stores the emergency call numbers input at step 103 to the memory 40, and proceeds to step 107. At step 107, the mobile communication terminal displays an input window for entry of a password to prevent unauthorized access to the mobile tracking feature. After a user inputs a desired password, the mobile communication terminal sets the input number as the password for the protection of the mobile tracking feature. Although the IMSI and the MS ISDN of the currently inserted SIM card are stored as the SIM card information as described above, the IMSI and MS ISDN may also be inputted by the user as the SIM card information to be stored along with the emergency call numbers. Further, the SIM card information corresponding to two or more SIM cards may be stored. The password for limiting access to the mobile tracking feature may also be optionally set.

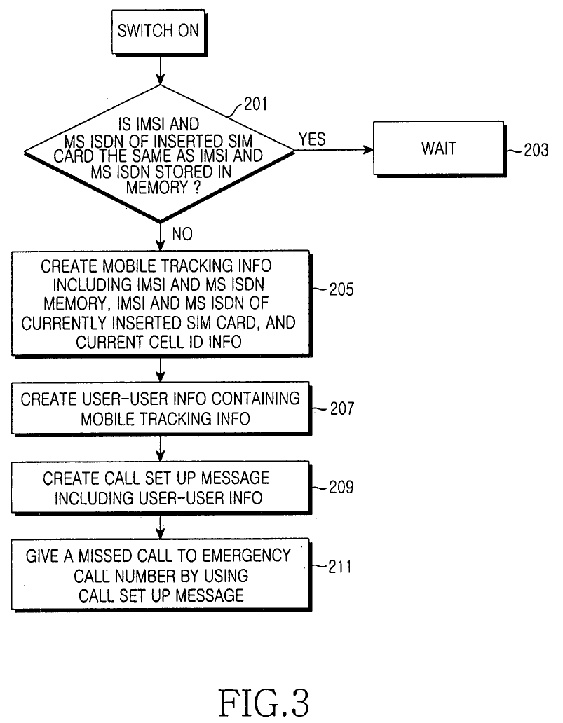

Hereinafter, with reference to FIG. 3, described below is a generation process of the missed call by the mobile communication terminal in the mobile tracking feature mode set as described above. FIG. 3 is a flowchart illustrating a process of the mobile communication terminal of an originating side.

In FIG. 3, when switched on, the mobile communication terminal checks whether the IMSI and MS ISDN of an inserted SIM are the same as the stored IMSI and MS ISDN stored in the memory 40 at step 201. Here, when the SIM card information in the memory 40 includes information corresponding to two or more SIM cards, the mobile communication terminal checks whether the SIM card information matches the SIM card information of the currently inserted SIM card. If the SIM card information are the same, the mobile communication terminal proceeds to step 203 and the tracking process ends. That is, the currently inserted SIM card is similar to the previously inserted SIM card or the SIM card registered by the user is certified. However, in step 201, if the IMSI and the MS ISDN of the currently inserted SIM card are not the same as the IMSI and the MS ISDN stored in the memory 40, the mobile communication terminal proceeds to step 205 and creates the mobile tracking information including the IMSI and the MS ISDN of the currently inserted SIM card, the IMSI and the MS ISDN stored in the memory 40, and the cell ID information at which the mobile communication terminal is currently located. Then, the mobile communication terminal proceeds to step 207. In this case, the mobile tracking information may be created in the form of a short message and transmitted through a Short Message Service (SMS).

At step 207, the mobile communication terminal creates user-user information Information Element (IE) using the mobile tracking information and proceeds to step 209. At step 209, the mobile communication terminal creates a call set up message including the user-user information IE and proceeds to step 211. Thereafter, the mobile communication terminal triggers a missed call function to places a phone call using the pre-defined emergency call numbers. Moreover, the mobile communication terminal may internally perform the operations corresponding to step 201 through 211 so that a new or unauthorized mobile terminal user is unaware that the tracking process is taking place. That is, the new mobile user is unaware of the process whereby the mobile communication terminal compares the information related to the currently inserted SIM card with the information stored in the memory 40 and the mobile communication terminal then triggers the missed call function based on the result of the comparison.

A mobile communication system discovers the locations of the mobile communication terminals on the terminating sides while receiving the call set up message, and then sends a call set up indication the user-user information IE containing the mobile tracking information for connecting a call to the mobile communication terminals on the terminating sides.

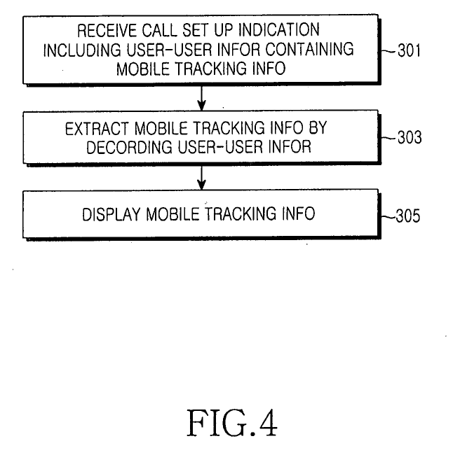

Hereinafter, with reference to FIG. 4, described is a process of one of the mobile communication terminals on the terminating sides which receives the missed call from the mobile communication terminal on the originating side, that is, a mobile communication terminal corresponding to one of the emergency call numbers. FIG. 4 is a flowchart illustrating a process of a mobile communication terminal of a terminating side. In FIG. 4, the mobile communication terminal on the terminating side receives the call set up indication including the user-user information IE containing the mobile tracking information at step 301 and proceeds to 303. At step 303, the mobile communication terminal on the terminating side decodes the user-user information IE to extract the mobile tracking information. Then, the mobile communication terminal on the terminating side proceeds to step 305 and displays the mobile tracking information to inform the owner of location information of the mobile terminal on the originating side. That is, the location information of the mobile communication terminal on the origination side may be encoded in appropriate formats so that a pre-defined interface device can decode the mobile tracking information in the same format as that used for encoding.

It will also be obvious to those skilled in the art that other control methods and apparatuses can be derived from the combinations of the various methods and apparatuses of the present invention as taught by the description and the accompanying drawings and these shall also be considered within the scope of the present invention. Further, description of such combinations and variations is therefore omitted above. It should also be noted that the host for storing the applications include but not limited to a microchip, microprocessor, handheld communication device, computer, rendering device or a multi function device.

Although the present invention has been fully described in connection with the preferred embodiments thereof with reference to the accompanying drawings, it is to be noted that various changes and modifications are possible and are apparent to those skilled in the art. Such changes and modifications are to be understood as included within the scope of the present invention as defined by the appended claims unless they depart there from.

According to the present invention, there is provided the method for tracking the lost mobile terminal, in which the mobile tracking information is passed to mobile communication terminals corresponding to pre-defined set of phone numbers, allowing the tracking including the location tracking of the mobile communication terminal.

What is claimed is:

1. A method for tracking a mobile communication terminal, the method comprising the steps of:
configuring a mobile tracking feature;
creating mobile tracking information when there is a difference between Subscriber Identity Module (SIM) card information stored in a SIM card currently being inserted into the mobile communication terminal and SIM card information stored in a memory after the mobile communication terminal is switched on, the mobile tracking information includes current location information of the mobile communication terminal; and
sending the mobile tracking information by generating a call to pre-defined emergency call numbers.

2. The method of claim 1, wherein each of the SIM card information includes International Mobile Subscriber Identity (IMSI) and Mobile Subscriber International Subscriber Number (MS ISDN).

3. The method of claim 2, wherein the mobile tracking information further includes the IMSI and the MS ISDN stored in the SIM card currently being inserted and subsequently the IMSI and the MS ISDN being stored in the memory.

4. The method of claim 3, wherein the step of configuring the mobile tracking feature comprises storing the emergency call numbers to the memory corresponding to a user selection of the emergency call numbers.

5. The method of claim 4, wherein the step of configuring the mobile tracking feature further comprises storing the IMSI and the MS ISDN stored in a SIM card being inserted into the mobile communication terminal when the emergency call numbers to the memory are stored.

6. The method of claim 4, wherein the step of configuring the mobile tracking feature further comprises storing the IMSI and the MS ISDN input by the user to the memory along with the emergency call numbers.

7. The method of claim 5, wherein the step of configuring the mobile tracking feature further comprises setting a password for providing password protection of the mobile tracking feature.

8. The method of claim 7, wherein the step of sending the mobile tracking information comprises creating user-user information Information Element (IE) containing the mobile tracking information, and including the user-user information IE into a call set up message.

9. The method of claim 8, wherein the step of sending the mobile tracking information comprises generating a call to the emergency call numbers using the call set up message.

10. The method of claim 9, wherein the method further comprises, when a call set up indication is received, extracting the mobile tracking information from the call set up indication and providing the mobile tracking information to the user.

11. The method of claim 10, wherein the mobile tracking information is a short message, the short message may be transmitted through a Short Message Service (SMS).
